(19) United States
(12) Patent Application Publication
(10) Pub. No.: US 2025/0089929 A1
(43) Pub. Date: Mar. 20, 2025

(54) BEVERAGE PREPARATION SYSTEM

(71) Applicant: SOCIETE DES PRODUITS NESTLE S.A., Vevey (CH)

(72) Inventors: CEDRIC BEAUSIRE, Bavois (CH); DIDIER VUAGNIAUX, Gimel (CH)

(21) Appl. No.: 18/293,270

(22) PCT Filed: Jul. 29, 2022
(86) PCT No.: PCT/EP2022/071432

§ 371 Date: Jan. 29, 2024

(30) Foreign Application Priority Data
Jul. 30, 2021 (EP) 21188906.8

(51) Int. Cl. A47J 31/44; A47J 31/40

(52) U.S. Cl. CPC A47J 31/4492; A47J 31/407

(57) ABSTRACT

The invention concerns a beverage production system comprising a pack (10) comprising a readable code and a module (1) for producing a beverage from said pack,—said module (1) comprising: a code reader, a movable fluid processing device (11) to introduce a fluid in said pack and to dispense a beverage from the pack, and. a pack holder assembly (2) comprising a pack chamber (22) and a movable interacting device (24) configured to move between:—a first interacting position wherein said locking device interacts with the pack (10) received in the chamber inside the pack holder assembly, and,—a second release position wherein said interacting device does not interact with the pack (10) received in the chamber, and said movable interacting device (24) comprises a movable pushing device configured to push the readable code (102) of the pack to the code reader (4) when the movable interacting device (24) is in the first fixing position.

### FIELD OF THE INVENTION

The present invention relates to a beverage system using packs of beverage ingredient.

### BACKGROUND OF THE INVENTION

WO 2021/110652 describes a beverage preparation machine for the preparation of beverages from packs holding beverage ingredients. The system machine a specific fluid processing device designed to pierce the bottom of a pack hold inside the machine, to introduce fluid therein through its fluid inlet and to dispense the beverage resulting from the mixing of the ingredient and fluid though a specific dispensing outlet of this device. Two different relative positions of the device and the pack enable either the introduction of fluid or the dispensing of beverage.

The packs used in this machine are generally made of a flexible material such as the flexible packages described in WO 2022/022902.

In the field of beverage system using a machine to prepare a beverage from a single dose container, the container can be provided with a code that supplies information about the beverage preparation to have the preparation more automatic for the user. The preparation information encoded by a code on the pack is read by the machine to define a recipe, and the recipe is used by the machine to optimise the preparation process in a manner specific to the container. In particular, the encoded preparation information may comprise operating parameters selected in the beverage preparation process, including: fluid temperature, fluid pressure, preparation duration and fluid volume.

Usually, codes can only be read from a rigid support of the container. For packs made of flexible material, a drawback is that a code is hardly readable from the flexible parts. It is a problem for the packs mentioned above.

Therefore, in spite of the effort already invested in the development of said systems further improvements are desirable.

### SUMMARY OF THE INVENTION

In a first aspect of the invention, there is provided a beverage production system comprising a pack and a module for producing a beverage from said pack,
said pack comprising an ingredient, said ingredient being configured to be mixed with a fluid to produce a beverage, said pack presenting a plane shape oriented along a plane (P) and comprising two longitudinal plane walls extending along this plane P, and
the bottom side of said pack being configured for being openable, and
said pack comprising a readable code, said code being positioned on at least one of the two longitudinal plane walls, and
said module comprising:
a movable fluid processing device configured to cooperate with the bottom of the pack to introduce a fluid in said pack and to dispense a beverage from the pack, and
a code reader,
a pack holder assembly, said pack holder assembly comprising a pack chamber and a movable interacting device wherein:
   the pack chamber is adapted for receiving said pack through an upper pack inlet and for holding said pack so that the plane (P) of the plane shape is oriented in an essentially vertical position inside the module, and
   said chamber presenting a bottom opening configured to enable access of the movable fluid processing device to at least the bottom side of said pack hold in the chamber, and said chamber presenting a side opening positioned in front of the code reader,
   the movable interacting device is configured to move between:
      a first fixing position wherein said interacting device interacts with the pack received in the chamber inside the pack holder assembly, and,
      a second release position wherein said interacting device does not interact with the pack received in the chamber, and
   said movable interacting device comprises a pushing device configured so that:
   when the movable interacting device moves to the first fixing position, said pushing device pushes the readable code of the pack received in the chamber to a reading head of the code reader until said readable code is in contact with the reading head,
   when the movable interacting device is in the second release position, said pushing device is positioned away from the pack received in the chamber.

This system comprises a pack comprising a food or beverage ingredient able to produce a beverage further to mixing with an aqueous fluid, preferably water.

This food or beverage ingredient packed in the package can be a water soluble powder or a soluble concentrate in liquid or semi-liquid form. In that embodiment water dissolves the beverage ingredient. The ingredient can be selected within the list of: soups, fruit juices, vegetable juices, bouillons, coffee, chocolate, tea, milk or creamer, smoothies, purees, coulis, creams or any combination thereof. Preferably, the food or beverage ingredient is a soluble food or beverage ingredient selected in the list of:
instant coffee powder, milk powder, cream powder, instant tea powder, cocoa powder, soup powder, fruit powder or mixture of said powders,
a coffee concentrate, a milk concentrate, a syrup, a fruit or vegetable concentrate, a tea concentrate, a fruit or vegetable puree.

The powders can be agglomerated or sintered. The powders or liquid concentrates can be mixed with solid pieces for example for preparing soups with solid or encapsulated pieces. This food or beverage ingredient packed in the package can also contain a food or beverage ingredient able to be infused like a roast and ground coffee, or tea leaves. In that embodiment water extracts the beverage ingredient.

The pack presents a plane shape oriented along a plane (P). This shape is provided by two longitudinal plane walls extending along this plane P. Preferably, the lateral edges of these two longitudinal plane walls are sealed to each other and form a sealing area, which is flat and flexible. Preferably most of the walls of the pack are made of flexible material. Yet in less preferred embodiments, the pack can be made at least partly of semi-flexible.

The pack comprises a readable code positioned on at least one of the two longitudinal plane walls, preferably close to the bottom of the pack. In one preferred embodiment, the code is positioned in a part of the sealing area. If the pack presents a symmetric geometry about its longitudinal plane, it is preferably that the pack is provided with at least two codes, one code being positioned on each longitudinal plane walls so that the pack can be introduced in whatever sense inside the pack chamber; that guarantees that at least one of the codes can be read by the code reader.

The code of the pack can be any type of code like: mechanical code, optical code (including colour code, codes printed with non-visible ink, one-dimension barcode, two dimensions bar code, QRcode), RFID tags, magnetic code, conductivity code. It is preferably an optical code.

Generally, the code provides directly or indirectly information related to the contained product, said information being comprised in the list of: identification of the product, quantity of product, beverage preparation parameters or any combinations thereof. The beverage preparation parameters can provide:
water volume, water temperature and/or water pressure, and/or
time sequence for water injection, air injection, pause, injection and dispensing in sequential or simultaneous manner.

The pack is configured for being openable at its bottom in order to introduce the fluid from below inside the pack and to dispense the prepared beverage from the pack through the same place. Preferably, an area of the bottom side is configured for being openable by piercing, tearing or puncturing in particular by applying an upwardly pointed, acute or sharp device, such as the fluid processing device, to said area. Preferably this area is positioned at the middle of the transversal dimension of the longitudinal shape of the pack. Preferably this openable area is made of a flexible material.

The system comprises a module for producing a beverage which comprises a fluid processing device configured to cooperate with the bottom of the pack to introduce a fluid in the pack in order to prepare a beverage inside the pack and then to dispense the prepared beverage from the pack. This fluid processing device can be the device described in WO 2021/110650. This fluid processing device is movable in different positions, said positions comprising at least one position where the device is out of the pack and at least one other position where the device is introduced inside the pack during the beverage preparation.

The module includes a code reading system with a code reader to read the code of the pack. Preferably, the code reading system of the module includes a code reader with an image capturing unit and a reading head housing the image capturing unit to capture a digital image of the code. The code reader may include an image capturing unit (e.g. a camera) a lens and an outermost aperture (e.g. a reading window). An outermost portion of the code reader may be referred to as a reading head.

In addition, said module comprises a pack holder assembly configured to hold the pack within the module.

This pack holder assembly comprises a pack chamber adapted for receiving a pack for a beverage preparation inside the module. The pack chamber comprises an upper pack inlet to introduce the new pack and the pack chamber is configured for holding the pack in an essentially vertical position inside the module. This vertical position guarantees the efficient preparation of the beverage and particularly the dispensing of the beverage from the pack so that the less possible liquid remains inside the pack at the end of the extraction and when the pack must be removed from the system to be thrown to the bin.

The pack chamber presents a bottom opening configured to enable an access of the movable fluid processing device to the bottom of said pack hold in the chamber. This access or passage is particularly designed to enable the upwards movement of the fluid processing device to the bottom of the pack when it is hold inside the chamber.

The pack holder assembly comprises a movable interacting device too. This interacting device is movable between two positions.

In its first fixing position, this interacting device interacts with the pack received in the chamber and preferably locks it inside the pack holder assembly.

In its second release position, this interacting device does not interact with the pack although the pack is present in the chamber.

This interacting device comprises a pushing device configured to be displaced with the interacting device, during this movement from the second release position to the first fixing position, to push the part of the pack that supports the readable code to the reading head of the code reader. The pushing device is positioned so as to push the part of the flexible longitudinal plane wall on which the code is present and that is accessible through the opening provided in the chamber. The movement of the pushing device is defined so that, when the interacting device is in its first fixing position, the part of the pack supporting the code is pinched between the surface of the pushing device and the surface of the reading head of the code reader. Consequently, efficient reading can be obtained on the flexible material of the pack.

The movement of the pushing device can be a short translation or a short rotation. Preferably, the surface of the pushing device and the surface of the reading head are plane and flat, and in the fixing position, these surfaces are parallel to each other.

When the movable interacting device is in the second release position, the pushing device is positioned away and is separated from the pack still present in the chamber. Accordingly, the pack can be removed from the chamber without interacting with the surface of the reading head, limiting damages of the surface of this head like scratching. The benefit is the same when the pack is introduced inside the chamber.

Preferably, this pack holder assembly comprises a door, said door being movable relatively to the pack chamber and being configured to be positioned in at least:
a first closed position wherein said door covers the pack inlet of the pack chamber and is able to enclose the pack inside the pack chamber, and
a second opened position wherein said door uncovers the pack inlet of the pack chamber, and
the movable interacting device is mechanically connected to the door so that it is configured to be pushed away from the chamber when the door is in the second opened position and to be pushed to the chamber when the door is in the first closed position.

In the first position called “closed”, the door covers the pack inlet of the pack chamber and is able to enclose the pack inside the pack chamber if one pack has been introduced inside the chamber, and consequently a beverage preparation is possible.

In the second position called “opened”, the door uncovers the pack inlet of the pack chamber and consequently the introduction of a pack inside the pack holder is enabled.

Due to the connection between the interacting device and the door, the position of the movable interacting device is coordinated with the position of the door so that the interacting device moves the pushing device when the door is closed and releases the pack when the door is opened, enabling in that last case the introduction or the removal of a pack in or out of the module.

In one preferred embodiment, the pack comprises at least two holes and/or deformable areas and the interacting device comprises corresponding locking means, preferably pins, said pins being configured to fit in said holes and/or deformable areas of the pack when the door is in the first closed position.

The at least two holes and/or deformable areas in the pack are usually provided transversally to the plane shape of the pack.

In one preferred embodiment, the pack comprises a front wall and a back wall, said front and back walls being made of flexible material, and at least the edges of the bottom parts of said walls are sealed together around the openable area of the bottom side, and the holes and/or deformable areas are provided in said sealed edges.

Preferably they are positioned symmetrically around the axis extending longitudinally along the middle of the plane shape of the pack.

Preferably they are positioned close to the bottom of the pack.

In the preferred embodiment, these holes are positioned in a part of the sealing area of the longitudinal plane walls of the pack.

The size (length and diameter) of the corresponding pins of the interacting device and the distance between the pins are set to enter in the two holes and/or deformable areas.

Usually, two holes and two pins are sufficient to fix the pack in the pack holding assembly.

Preferably in the system, the fluid processing device comprises:
at least one fluid inlet for introducing a fluid into the pack hold in the chamber for the preparation of a beverage by mixing said fluid with the ingredient contained in said pack, and
at least one beverage outlet for dispensing said prepared beverage from said pack hold in the chamber.

In such a preferred embodiment, the fluid processing device corresponds to one of the devices disclosed in WO 2021/110650, WO 2021/110652 or WO 2021/110654.

Preferably, an actuating device (such as a motor) is configured to move the fluid processing device to the pack whereas the pack is hold in the chamber in a fixed manner.

In the present invention, fluid covers either any aqueous diluent that can be mixed with a soluble beverage ingredient to prepare a beverage, like water, carbonated water, milk, etc. (preferably, water is the preferred aqueous diluent) or any gaseous fluid such as for example air. When referring to aqueous fluid, water is the preferred fluid; when referring to gaseous fluid, air is the preferred fluid.

According to the invention, the package is arranged essentially vertically during the production and dispensing of the food or beverage product.

According to the present invention, the aqueous fluid, typically water, is supplied into the package at any temperature: cold, ambient or hot, depending on the type of food or beverage product to be prepared.

Preferably, the module comprises:
a receiving area configured to receive and hold the pack holder assembly, and
an electrical switch, and
when the pack holder assembly is in said receiving area, a contacting part of the door is designed to cooperate with the electrical switch so that:
in the second opened position of the door, the contacting part of the door directly or indirectly switches off the electrical switch, and
in the first closed position of the door, the contacting part of the door directly or indirectly switches on the electrical switch.

This electrical switch of the module enables the automatic preparation of a beverage with the system, in particular the supply of electrical power to the different electrical devices of the machine such as the actuating device of the fluid processing device.

The door can cooperate directly with this switch through a shape designed to push the switch when the door is closed or indirectly through a movable member designed to move relatively to the electrical switch of the module between a first and a second position, wherein in the first position said movable member releases said electrical switch and a second position said movable member pushes said electrical switch.

With this automatic switch off of electrical power when the door is opened, no risk of injury of the user can happen for example by sudden projection of hot water from the fluid processing device while no pack is present in the assembly and the door is opened.

Preferably, the module comprises a receiving area configured to receive and hold the pack holder assembly and said receiving area comprises at least one first magnet, and the door comprises at least one corresponding second magnet, and said first magnet and second magnet are positioned in the receiving area and in the door respectively so that, when the door is closed, the first and second magnets cooperate. It has been observed that during a beverage preparation, in particular with a pack made of flexible walls, this pack can inflate inside the chamber and can exert a force on the inside wall of the door such that the door is pushed away and opens during the preparation. Magnets cooperating between the door and the receiving area of the module prevent this undesired sudden opening.

It is preferred that said first magnet and second magnet are positioned at the upper parts of the receiving area and of the door respectively. Actually, it was observed that it is the upper part of the pack hold in the chamber that inflates and opens the door. By exerting an attraction force between the door and the receiving area at the upper part of the door, the risk that the door opens is limited. For the same reason, it is preferred that the first and second magnets are positioned close to the contacting part of the door designed to interfere with the electrical switch of the module. Consequently, it is preferred that said contacting part of the door is positioned in the upper part of the door.

Preferably, the pack chamber comprises at least one internal front wall, this internal front wall being positioned below the movable door, and at least one rib rises from said internal front wall inside the chamber.

By extending inside the chamber, the end of this rib is close to the surface of the pack or even contacts this surface. Such a rib helps to prevent the upper part of the pack to inflate too much as mentioned above and to prevent the sudden opening of the door too. Preferably several ribs are designed in the internal front wall.

In a second aspect of the invention, there is provided a pack holder assembly for a beverage production system such as described above, wherein said pack holder assembly comprises a pack chamber and a movable interacting device wherein:
the pack chamber defines an internal volume adapted for receiving a pack through an upper pack inlet and for holding said pack, and said chamber presents a side opening configured to face the code reader of the module,
the movable interacting device is configured to move between a first fixing position and a second release position, and said movable interacting device comprises a pushing device configured so that:
when the movable interacting device is in the first interacting position, said pushing device is positioned inside the internal volume of the chamber, and
when the movable interacting device is in the second release position, said pushing device is removed from the internal volume of the chamber.

By “removed from the internal volume of the chamber”, it is meant that, in this position, the pushing device does not extend in the internal volume to a position where it prevents the introduction and correct positioning of a pack in the chamber.

Preferably, the pack holder assembly comprises a door, said door being movable relatively to the pack chamber and being configured to be positioned in at least:
a first closed position wherein said door covers the pack inlet of the pack chamber, and
a second opened position wherein said door uncovers the pack inlet of the pack chamber, and
wherein the movable interacting device is mechanically connected to the door so that it is configured to be pushed away from the chamber when the door is in the second opened position and to be pushed to the chamber when the door is in the first closed position.

Preferably, the door comprises at least one magnet, said magnet being positioned at the upper side of the door.

Preferably, the door comprises a contacting part designed to cooperate with an electrical switch of the module, and this contacting part is positioned in the upper part of the door.

In a third aspect, there is provided the use of a pack holder assembly such as described in the above second aspect in a beverage production system such as described in the above first aspect.

In the present application the terms “internal”, “back”, “front”, “top” “bottom”, “lateral”, “upper” and “lower” are used to describe the relational positioning of features of the invention. These terms should be understood to refer to the pack in its normal orientation when positioned in a beverage preparation dispenser for the production of a beverage as shown in the FIGS. 4A-4C.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIG. 1 is a schematic drawing of a beverage production system according to the invention,

FIG. 2 is perspective view of a pack that can be used in the beverage production system,

FIG. 3 is perspective view and a cross section view of a fluid processing device that can be used in the beverage production system,

FIGS. 4A-4C are views of the beverage production system according to the invention,

FIG. 4D is a view of back wall of the receiving area of the module of FIGS. 4A-4C,

FIGS. 4E and 4F are views of the back side of the pack holder assembly without a pack and with a pack respectively,

FIGS. 5A and 5B are side view and horizontal cross sectional view along C-C of the pack chamber with the door opened,

FIGS. 6A and 6B are vertical section of the bottom of the pack holder assembly of FIGS. 5B and 5B respectively,

FIGS. 7A and 7B are cross-sectional view of the pack holder assembly of FIGS. 6A and 6B respectively taken along plane CC,

FIGS. 8A-8B are views of the module of the beverage production system illustrating the locking means of the door,

FIG. 9 is a perspective top view of the of the pack chamber with the door opened and a pack inside,

### DETAILED DESCRIPTION OF EXEMPLARY EMBODIMENTS

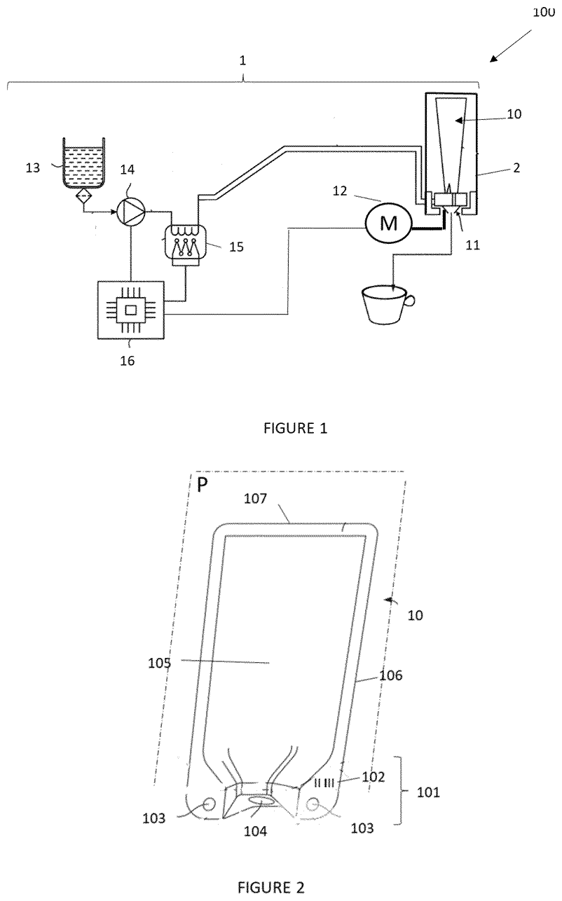

FIG. 1 illustrates schematically a beverage production system 100 according to the invention.

The system 100 comprises a module 1 and a pack 10. The module is adapted for receiving the pack and producing a beverage from said pack.

The module 1 comprises a pack holder assembly 2 and a fluid system to introduce a fluid inside the pack.

The fluid system usually comprises a fluid source 13, like a water tank, pumping means 14 to pump the fluid from the source. Usually heating and/or cooling means are part of the system to adapt the temperature of the fluid to be introduced inside the pack.

The fluid is supplied to a fluid processing device 11 configured to cooperate with the bottom of the pack in order to introduce the fluid in said pack.

Generally, the module comprises am actuating device 12 move this fluid processing device 11 to said pack hold in the pack holder assembly 2.

The module comprises usually a system control unit 16 to control the above different devices for the preparation of a beverage from a pack.

Such a beverage production system 100 corresponds to the system described in the publications WO 2021/110650, WO 2021/110654 and/or WO 2021/110652.

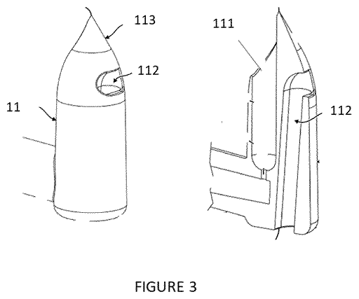

FIG. 2 is a perspective view of a pack 10 that can be used in the beverage production system 100 according to the invention.

This pack comprises an ingredient that is configured to be mixed with a fluid to produce a beverage. The pack presents a plane shape oriented along a plane P. Two longitudinal plane walls 105 (front and back) extends along this plane P. In the preferred embodiment, these walls are made of a flexible material and the lateral edges 106 of these walls are sealed as well as the edges at the top end 107. The bottom side 101 of said pack is configured for being openable, preferably through a pierceable area 104. The openable area is positioned at an edge of the plane P and enables the dispensing of the beverage along a direction comprised in this plane P.

In the particular illustrated embodiment, the pack comprises two holes 103 at the bottom side 101. These holes are positioned around the openable area 104 of the bottom side of the pack.

The pack 10 comprises a readable code 102 in its bottom side 101.

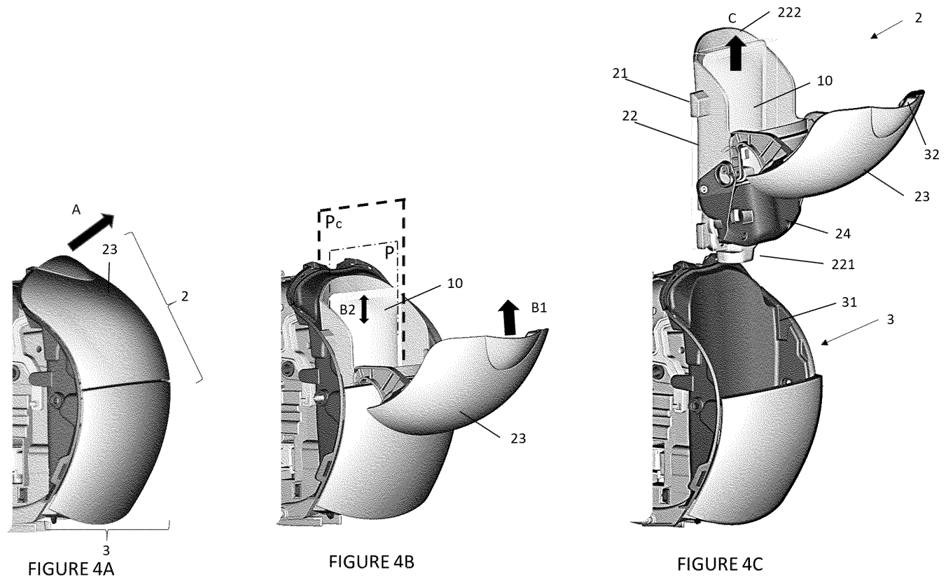

FIG. 3 is perspective view and a cross section view of a fluid processing device 11 that can be used in the beverage production system. It comprises:
a fluid inlet 111 for introducing a fluid into the openable area 104 of the pack hold in the chamber, and
a beverage outlet 112 for dispensing the prepared beverage from said pack hold in the chamber.

The actuating device 12 is adapted to move this fluid processing device 11 to said pack hold in the chamber and in particular the pointed part 113 to the openable area 104 in order to open the openable area 104 or any membrane or cover provided at this area. Usually, the fluid processing device is adapted to move along a direction that is comprised in the plane P of the pack.

Other fluid processing device 11 such as described in WO 2021/110650 can be used in the system of the present invention.

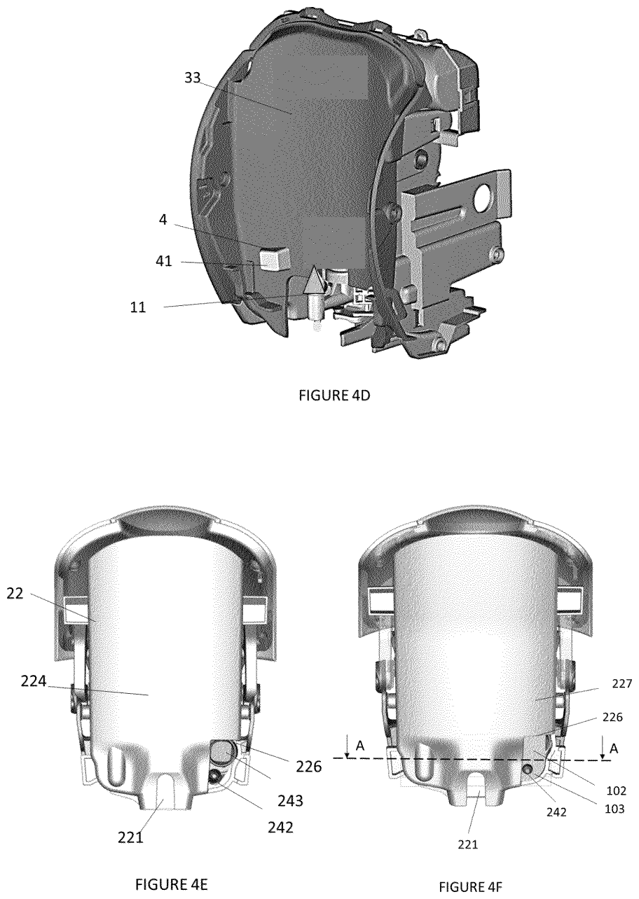

FIGS. 4A to 4C illustrates the part of the module 1 configured to receive the pack. This part of the module comprises a pack holder assembly 2 hold in a receiving area 3 of the module. This

In FIG. 4A, the pack holder assembly 2 is positioned inside the receiving area 3. The pack holder assembly comprises a door 23 that can be opened, as illustrated by the arrow A.

When the door is opened, as illustrated in FIG. 4B, a pack 10 can be introduced in the pack chamber 22 of the pack holder assembly 2 or removed therefrom as desired by the operator and as illustrated by the arrows B2. It can be observed that the plane P of the pack extends along the plane Pc defined by the walls of the pack chamber 22. In the particular embodiment of FIGS. 4A-4C, the whole pack holder assembly 2 can be removed from the receiving area 3 for example by handling the door 23 and pulling it upwardly as illustrated by the arrow B1. In alternative embodiments, the pack holder assembly may not be removable from the receiving area or may be removable by pulling upwardly a handle at the upper part of the holder assembly or any other means to withdraw the assembly. Generally, it is preferable that the pack holder assembly 2 is removable for cleaning operations.

In addition, when the whole pack holder assembly 2 is removable from the receiving area 3, as shown in the FIG. 4C, it can be used by the operator to bring a used pack 10 to the bin, which prevents manipulating the pack that may still contain liquid close to the machine. Then the pack holder assembly 2 can be positioned back inside the receiving area 3: guiding means 21 on the wall of the pack chamber 22 cooperates with corresponding guiding means 31 of the receiving area.

FIG. 4D is a view of back wall 33 of the receiving area of the module of FIGS. 4A-4C wherein the pack holder assembly was removed and showing the code reader 4 and the fluid processing device 11.

The code reader 4 with its reading head 41 is oriented in direction of the pack holder assembly 2. The axis of the code reader 4 is oriented perpendicularly to the planes P, Pc of the pack and the chamber so that the part of the pack supporting the code 102 is arranged normal to and through a reading direction of the reading head (which is the direction in which code reader obtains an image of the code).

The fluid processing device 11 is at the bottom of the receiving area 3 and oriented upwardly in direction of the bottom of the pack holder assembly.

FIG. 4E is a view of the back side of the pack holder assembly without a pack being introduced inside the chamber. The chamber comprises a bottom opening 221 designed to enable the introduction of the fluid processing device 11 inside the openable bottom of the pack hold in the chamber.

The back wall 224 of the chamber comprises a side opening 226 that faces the code reader 4 when the chamber is positioned inside the receiving area of the module. Accordingly, when a pack is hold in the chamber 22, the part of the pack bearing the code 102 is positioned at this opening 226 and is accessible for reading by a code reader of the module as illustrated in FIG. 4F that shows the back side of the pack holder assembly with a pack present inside the chamber

The pack holder assembly comprises a movable pushing device 243, visible on FIG. 4E, actuated by a movable interacting device of the assembly as described below.

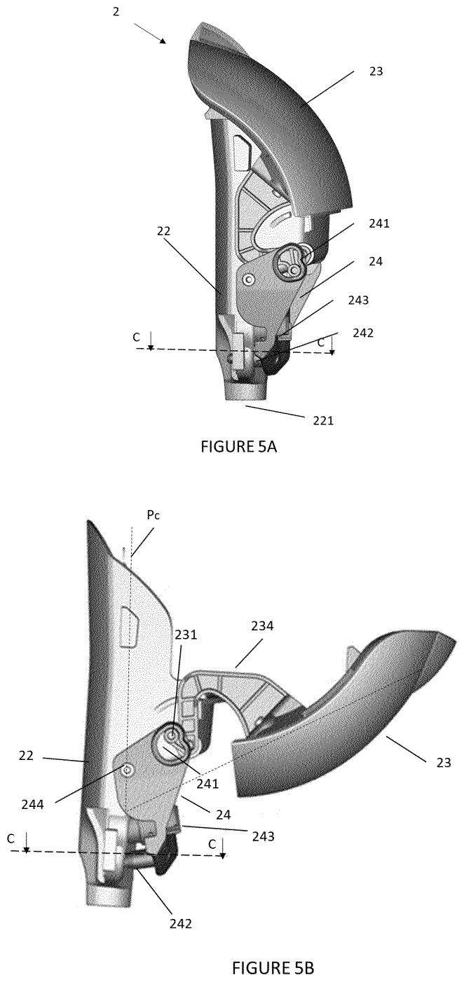

FIGS. 5A and 5B illustrate the pack holder assembly of FIGS. 4A and 4B. This pack holder assembly comprises an interacting device 24 that is configured to move between:
a first fixing position wherein said interacting device interacts with the pack received in the chamber, as illustrated in FIG. 5A and,
a second release position wherein said interacting device does not interact with the pack received in the chamber, as illustrated in FIG. 5B

By “interacting”, it is meant that the interacting device is close to and in contact with a part of the pack. In FIG. 5A, the bottom of the interacting device is close to the bottom of the pack in its interacting position, whereas in FIG. 5B, the bottom of the interacting device is away from the bottom of the pack in its release position.

The movable interacting device 24 supports a movable pushing device 243 and consequently, this pushing device is displaced in accordance with the movement of the interacting device.

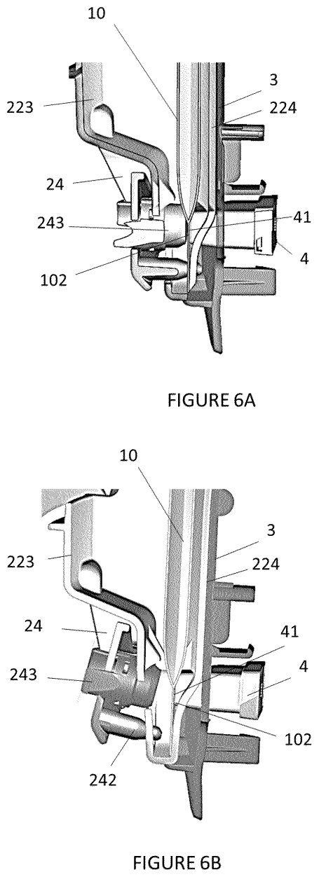

Since, in the second release position of FIG. 5B, the movable interacting device 24 is tilted away from the pack and the chamber 22, the pushing device 243 is away from the internal volume of the chamber too and does not limit the movement of the pack. The pack can be introduced and removed easily from the chamber. FIG. 6B is vertical section of the bottom of the pack holder assembly of FIG. 5B inside the module 1 and illustrating the relative positions of the pack 10, the reading head 41 and the pushing device 243. In this position, the pack 10 can be received or removed from the chamber. During this movement, the part of the pack that supports the readable code 102 can move freely relatively to the code reader head 41, preferably without contacting it which could scratch the reader head of the code reader with time.

On the contrary, in the first interacting position of FIG. 5A, the movable interacting device 24 is pulled to the chamber 22 and, accordingly, the pushing device 243 enters the internal volume of the chamber and pushes the part of the pack comprising the readable code 102 to the reading head 41 of the code reader 4 until said readable code is in contact with the reading head 41 as illustrated in FIG. 6A that is a vertical section of the bottom of the pack holder assembly of FIG. 5A inside the module 1. In that position, the flexible part of the sachet bearing the code is pinched between the reading head and the pushing device and the reading operation is improved.

By arranging the pushing device 243 to press to code 102 into the reading head, it may be ensured that the code is aligned with and at a precise distance to the code reader, which may improve reading accuracy.

Preferably, the reading head of the code reader is shaped to correspond in shape to a shape of the pushing device (e.g. the centres of their surfaces). For example, a head of the reader may be flat and/or curved to correspond in shape to the pushing device. A flat or slightly curved head may provide easier reading of the code due to less distortion of the optics. The sachet 10 is hold inside the chamber so that its code 102 is in front of the code reader. In addition, as the door of the pack holder assembly is closed, its locking device 24 moves the pushing device 243 to the code reader 4 so that the part of the pack holding the code 102 and positioned between the pushing device and the code reader is urged in direction of the reader until the code is in contact with the reading head 41 of the code reader. As a result, reading is improved.

With the fluid processing device being positioned in the area of the code reader, vapour may deposit on the surface of the reading head or on the surface of the pack bearing the code and may prevent good reading. By pushing the part of the pack with the code to the reading head, the drawbacks of vapour from the fluid processing device can be avoided. Any debris from the processing unit (e.g. steam or precursor material) that is present on the code and would otherwise interfere with the code reading is displaced.

In one preferred embodiment, the pushing device 243 can be spring loaded in order to provide a softer contact during the movement towards the reading head that could be damaged after numerous operations.

Although, the illustrated embodiment shows the code 102 provided on the flat sealing area of the pack, the code can also be provided on another area of the longitudinal walls 105 and in that case, the pushing device provides a flattening function of the flexible wall during the code reading operation.

In the system of the invention, the position of the readable code 102 on the pack 10 is such that this code is visible through the side opening 226 of the chamber positioned in front of the code reader.

Similarly, the positions of the pushing device 243 and the side opening 226 in the locking device are set relatively to the position of the code reader 4 inside the module.

In the illustrated embodiment, it appears that this movable interacting device 24 is mechanically connected to the door 23 so that it is configured to be tilt away from the chamber 22 when the door is in the second opened position.

The opening movement of the door 23 is a rotation along hinges 231 attached to the side walls of the chamber 22. The door is connected to each of said hinges by arms 234 presenting a shape configured to enable the position of the door in the first opened position either when the assembly 2 is hold in the receiving area 3 of the module, as illustrated in FIG. 4B, or when the assembly 2 is fully removed from the module, as illustrated in FIG. 4C. For this reason, the arm is configured to skirt round the upper edge of the fixed lower cover 6 of the receiving area.

The movable interacting device 24 is attached to the lateral walls of the chamber through dedicated hinges 244 enabling the rotation of said device. In addition, the movable interacting comprises a hole 2445 designed to cooperate with the hinges 231 of the door, so that:
when the door 23 is opened, the bottom of the interacting device is tilted away from the pack chamber and the interacting device 24 is in its second release position,
when the door 23 is closed, the bottom of the interacting device is moved to the pack chamber and the interacting device 24 is in its first fixing position,
In addition, in the specific illustrated embodiment, this interacting device 24 comprises two pins 242 configured to fit in corresponding holes 103 of the pack when the door 23 is in the first closed position.

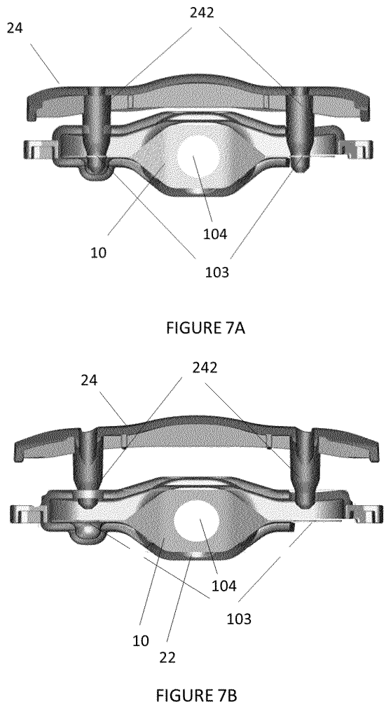

In FIG. 7B corresponding to the cross-sectional view of the assembly 2 taken along plane CC of FIG. 6B, these two pins 242 are positioned away from the holes 103. In this position where the door 23 is opened, the operator is able to remove the pack form the pack holder or to introduce a new one if the chamber is empty.

FIG. 7A corresponds to the same section as FIG. 7B but in the situation where the door 23 is in the first closed position as illustrated in FIG. 6A. Then, the bottom of the interacting device 24 is positioned close to the chamber 22 and, consequently, the pins 242 enter in the holes 103 of the pack that is present in the chamber. These corresponding pins and holes enable a correct position of the pack inside the chamber which guarantees a correct interaction with the fluid processing device 11. They also maintain firmly the pack during the introduction of the fluid processing device 11 and they prevent the upwardly movement of the pack inside the chamber when a fluid squirts inside the pack.

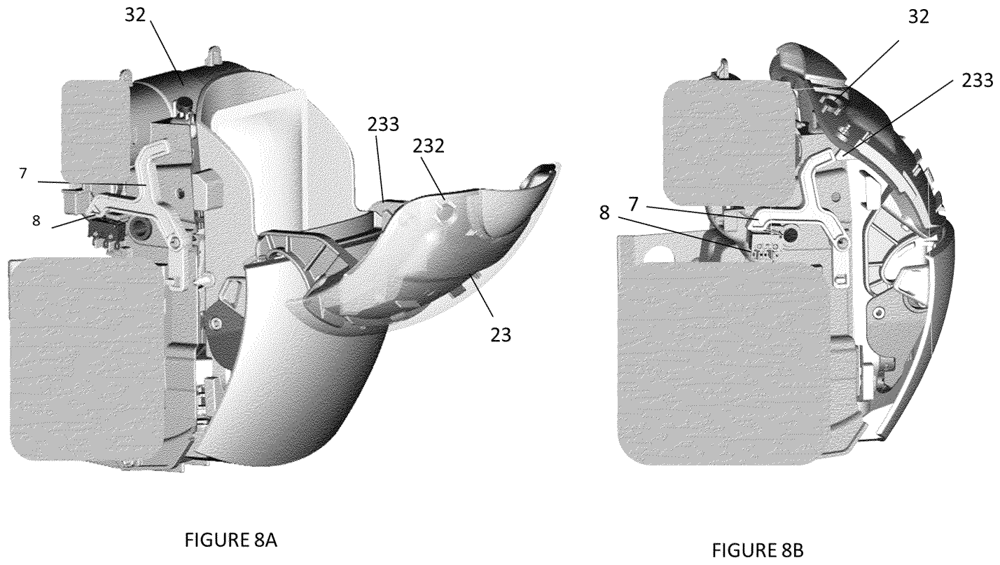

FIGS. 8A and 8B illustrates one preferred embodiment of the door 23 of the pack holder assembly.

Generally, the module comprises an electrical switch 8 that can be switched on or off depending on the position of the door, precisely if the door 23 is closed or opened. In particular, a part 233 of the door can be designed to move a member 7 configured to switch on the electrical switch.

Preferably, the receiving area 3 comprises at least one first magnet 32 and the door 23 comprises at least one corresponding second magnet 232 positioned in the receiving area and in the door respectively so that, when the door is closed, the first and second magnets cooperate. The position of these both magnets improves the closure of the door 23 during the beverage preparation when a pack inflates too much and is able to push and open the door. The position of the magnets close to the part 233 of the door designed to switch on the electrical switch improves the effect and holds the door even more firmly. Magnets provided at a lower position of the door were less efficient in keeping the door closed when the pack inflated.

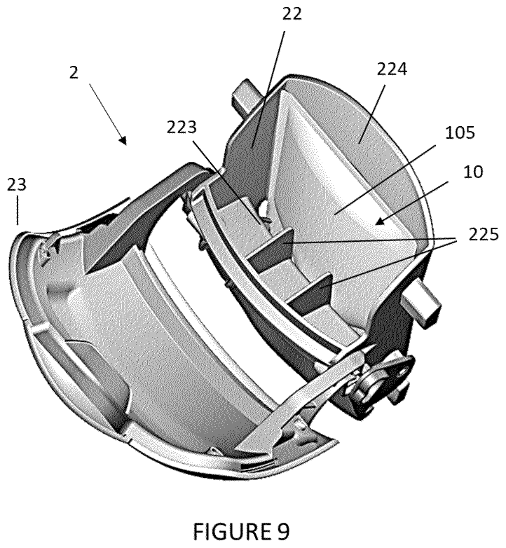

FIG. 9 is a top view of the opened pack holder assembly 2 with a pack 10 inside the chamber 22. In this preferred embodiment, below the door 23, the internal front wall 223 of the pack chamber comprises two ribs 225 that rise from this wall in direction of one of the longitudinal plane wall 105 of the pack. During the introduction of liquid at the bottom of the pack, these ribs 225 prevent an inflating of the wall 105 of the pack that could exert a force on the internal wall of the door and the opening of the latter. These ribs guarantee that the wall 105 of the pack remain away from the door 23 during the preparation.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

system 100
module 1
   fluid processing device 11
      inlet means 111
      outlet means 112
      pointed part 113
   actuating device 12
   fluid source 13
   pumping means 14
   heating and/or cooling means 15
   system control unit 16
pack holder assembly 2
   guiding means 21
   pack chamber 22
      bottom opening 221
      pack inlet 222
      internal front wall 223
      back wall 224
      rib 225
      side opening 226
   door 23
      hinge 231
      magnet 232
      contacting part 233
      arm 234
   locking device 24
      connection 241
      pins 242
      pushing device 243
      hinge 244
receiving area 3
   guiding means 31
   magnet 32
   back wall 33
code reader 4
frame 5
attached cover 6
movable member 7
electrical switch 8
   pack 10
   bottom side 101
   code 102
   hole 103
   pierceable area 104
   longitudinal plane wall 105
   lateral sealed edge 106
   top end 107

1. A beverage production system comprising a pack and a module for producing a beverage from said pack,
said pack comprising an ingredient, said ingredient being configured to be mixed with a fluid to produce a beverage,
said pack presenting a plane shape oriented along a plane and comprising two longitudinal plane walls extending along this plane, and
the bottom side of said pack being configured for being openable, and
said pack comprising at least one readable code, said code being positioned on at least one of the two longitudinal plane walls, and
said module comprising:
a movable fluid processing device configured to cooperate with the bottom of the pack to introduce a fluid in said pack and to dispense a beverage from the pack, and
a code reader,
a pack holder assembly, said pack holder assembly comprising a pack chamber and a movable interacting device wherein:
the pack chamber is adapted for receiving said pack through an upper pack inlet and for holding said pack so that the plane of the plane shape is oriented in an essentially vertical position inside the module, and
said chamber presenting a bottom opening configured to enable access of the movable fluid processing device to at least the bottom side of said pack hold in the chamber, and
said chamber presenting a side opening positioned in front of the code reader,
the movable interacting device is configured to move between:
a first fixing position wherein said interacting device interacts with the pack received in the chamber, and,
a second release position wherein said interacting device does not interact with the pack received in the chamber, and
wherein said movable interacting device comprises a pushing device configured so that:
when the movable interacting device moves to the first fixing position, said pushing device pushes the readable code of the pack received in the chamber to a reading head of the code reader until said readable code is in contact with the reading head,
when the movable interacting device is in the second release position, said pushing device is positioned away from the pack received in the chamber.

2. System according to claim 1, wherein the lateral edges of two longitudinal plane walls of the pack are sealed to each other and form a sealing area and the readable code is positioned at least on a part of said sealing area.

3. System according to claim 2, wherein the readable code is positioned on a sealing area close to the bottom of the pack.

4. System according to claim 1, wherein the pack holder assembly comprises a door-, said door being movable relatively to the pack chamber and being configured to be positioned in at least:
a first closed position wherein said door covers the pack inlet of the pack chamber and is able to enclose the pack inside the pack chamber, and
a second opened position wherein said door uncovers the pack inlet of the pack chamber, and
wherein the movable interacting device is mechanically connected to the door so that said movable interacting device is configured to be pushed away from the chamber when the door is in the second opened position and to be pushed to the chamber when the door is in the first closed position.

5. System according to claim 1, wherein the pack comprises at last two holes and/or deformable areas and the locking device comprises corresponding locking means, preferably pins, configured to fit in said holes and/or deformable areas of the pack when the door is in the first closed position.

6. System according to claim 1, wherein the fluid processing device comprises:
at least one fluid inlet for introducing a fluid into the pack hold in the chamber for the preparation of a beverage by mixing said fluid with the ingredient contained in said pack, and
at least one beverage outlet for dispensing said prepared beverage from said pack hold in the chamber.

7. System according to claim 1, wherein:
the module comprises:
a receiving area configured to hold the pack holder assembly-, and
an electrical switch,
and
when the pack holder assembly is positioned in said receiving area-, a contacting part of the door is designed to cooperate with the electrical switch so that:
in the second opened position of the door, said contacting part of the door directly or indirectly switches off the electrical switch, and
in the first closed position of the door, said contacting part of the door directly or indirectly switches on the electrical switch.

8. System according to claim 1, wherein:
the module comprises a receiving area configured to receive and hold the pack holder assembly and said receiving area comprises at least one first magnet-, and
the door comprises at least one corresponding second magnet,
wherein said first magnet and said second magnet are positioned in the receiving area and in the door respectively so that, when the door is closed, the first and second magnets cooperate.

9. System according to claim 1, wherein said first magnet and said second magnet are positioned at the upper parts of the receiving area and of the door respectively.

10. System according to claim 1, wherein the contacting part of the door is positioned in the upper part of the door.

11. System according to claim 1, wherein the pack chamber comprises an internal front wall-, said internal front wall being positioned below the movable door, and
wherein at least one rib rises from said internal front wall inside the chamber.

12. Pack holder assembly for a beverage production system, said system comprising a pack and a beverage producing module, said pack presenting a plane shape oriented along a plane and comprising two longitudinal plane walls extending along said plane and comprising a readable code, said code being positioned on at least one of the two longitudinal plane walls, and the beverage producing module comprising a code reader,
said pack holder assembly comprising a pack chamber and a movable interacting device wherein:
the pack chamber defines an internal volume adapted for receiving a pack through an upper pack inlet and for holding said pack, and said chamber presents a side opening configured to face the code reader of the module,
the movable interacting device is configured to move between a first fixing position and a second release position, and said movable interacting device comprises a pushing device configured so that:
when the movable interacting device is in the first interacting position, said pushing device is positioned inside the internal volume of the chamber, and
when the movable interacting device is in the second release position, said pushing device is removed from the internal volume of the chamber.

13. Pack holder assembly for a beverage production system according to claim 1, wherein the pack holder assembly comprises a door, said door being movable relatively to the pack chamber and being configured to be positioned in at least:
a first closed position wherein said door covers the pack inlet of the pack chamber, and
a second opened position wherein said door uncovers the pack inlet of the pack chamber, and
wherein the movable interacting device is mechanically connected to the door so that it is configured to be pushed away from the chamber when the door is in the second opened position and to be pushed to the chamber when the door is in the first closed position.

14. Pack holder assembly for a beverage production system according to claim 13, wherein the door comprises at least one magnet, said magnet being positioned at the upper side of the door.

15. Pack holder assembly for a beverage production system according to claim 13, wherein the door comprises a contacting part designed to cooperate with an electrical switch of the module, said contacting part being positioned in the upper part of the door.

16. (canceled)
